(19) United States
(12) Patent Application Publication
(10) Pub. No.: US 2007/0279854 A1
(43) Pub. Date: Dec. 6, 2007

(54) Protecting device for electrical cable

(76) Inventor: Sung-Ming Song, Taipei (TW)

Correspondence Address: HARNESS, DICKEY & PIERCE, P.L.C., P.O. BOX 8910, RESTON, VA, 20195, US

(21) Appl. No.: 11/445,292

(22) Filed: Jun. 2, 2006

(51) Int. Cl. G06F 1/16

(52) U.S. Cl. 361/683

(57) ABSTRACT

A protecting device for electrical cable is provided, which is disposed in an electronic device with two bases pivotally connected to each other. Each of the bases has a pivot portion, and the pivot portions are pivotally connected to each other. The protecting device is disposed across the two pivot portions for an electrical cable passing through. Then the cable is protected by the protecting device, and is prevented from being worn and damaged due to relative rotation of the two bases. Thus the lifetime of the electrical cable is extended.

### BACKGROUND OF THE INVENTION

1. Field of Invention

The present invention relates to a cable electrical connected to two bases, and more particularly to a protecting device for protecting an electrical cable passing through thereof between two pivotally connected bases.

2. Related Art

Referring to FIG. 1, it shows a notebook 10 in the prior art. The notebook 10 comprises a main body 101 and a display screen 102. The main body 101 and the display screen 102 are pivotally connected with each other through pivot portions 1011, 1012, and 1021, so that the display screen 102 can be rotated relative to the main body 101.

Referring to FIG. 2, it shows an exploded view of the notebook 10 in the prior art. As illustrated, both the main body 101 and the display screen 102 are electrically connected to each other with electrical cables 1031, 1032 passing through the pivot portions between the main body 101 and the display screen 102. The through holes of each pivot 1011, 1012, and 1021 is used for cables 1031, 1032 passing through, such that the cables 1031, 1032 can be completely set to be hidden inside the pivots 1011, 1012 without being exposed, which is primarily for providing proper protection of the cables 1031, 1032, as well as providing the notebook 10 with a desirable overall external appearance. However, the display screen 102 needs to be turned to be opened when being used and to be closed after having been used, such that its open or close action is repeated continuously. During the above repeated open or close action, the cables 1031, 1032 are subjected to friction between the pivots 1011, 1021, such that the cables 1031, 1032 are worn and damaged, even being cut off, which may directly influence the usage and operation of the computer.

### SUMMARY OF THE INVENTION

In view of the problem in the art, the subject of the present invention is directed to an improvement of a pivot portion structure, which provides protection for electrical cables.

The protecting device for an electrical cable of the present invention is disposed across two pivotally connected bases, which includes a hollow tube disposed across the two bases for an electrical cable passing through thereof. The protecting device prevents the cable from being worn and damaged by friction generated relative rotation of the two bases, thus the electrical cable is protected well and its lifetime is extended.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is perspective view a notebook of the prior art;

FIG. 2 is an exploded view of the notebook of the prior art;

FIG. 3A is a perspective of a embodiment the present invention with a base having a pivotally connected portion;

FIG. 3B is a partial enlarged view of FIG. 3A;

FIG. 4A is a front view of a electronic device of a second embodiment of the present invention;

FIG. 4B is a partial enlarged view of FIG. 4A; and

FIG. 5 is a front view of a third embodiment of the present invention.

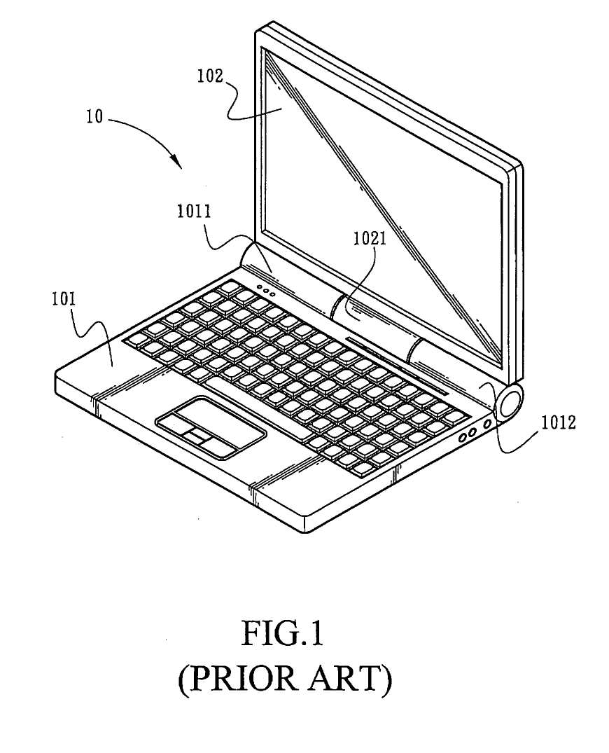

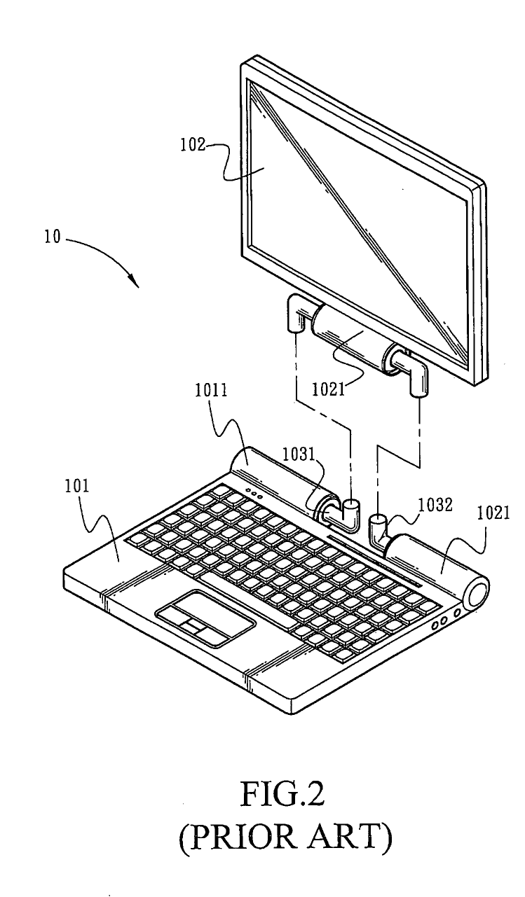

### DETAILED DESCRIPTION OF THE INVENTION

In order to have a further understanding of objects, construction, characteristics, and functions of the invention, the invention is illustrated in detail accompanied with embodiments as follows.

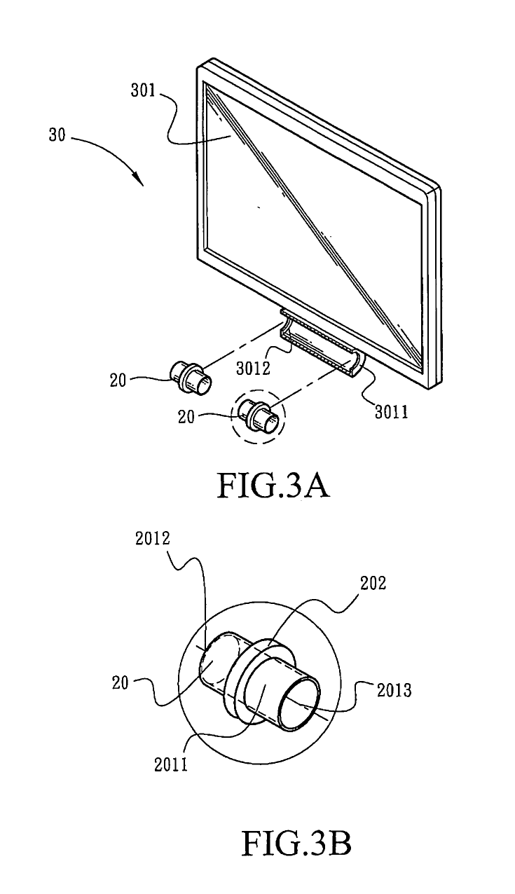

Referring to FIGS. 3A and 3B, FIG. 3A is a perspective view of the protecting device of a first embodiment the present invention, and FIG. 3B is a partial enlarged view of FIG. 3A

The protecting device 20 for an electrical cable of the first embodiment is a hollow tube with a hollow passing portion 2011, and two ends of the tube 201 are respectively a first opening 2012 and a second opening 2013. An annular coupling portion 202 is formed on the external peripheral of the tube 201, which is an annular flange protruding form the external peripheral of the protecting device 20.

The protecting device 20 for an electrical cable of the embodiment of the present invention is disposed in an electronic device 30, wherein a first pivot portion 3011 is formed on a first base 301, and both ends of the first pivot portion 3011 are respectively provided with a positioning surface 3012. The protecting device 20 is disposed in the first pivot portion 3011 and protruding outward with its coupling portion 202 pressing against the positioning surface 3012 of the first pivot portion 3011 for the protecting device 20 being coupled with the first base 301 and positioned.

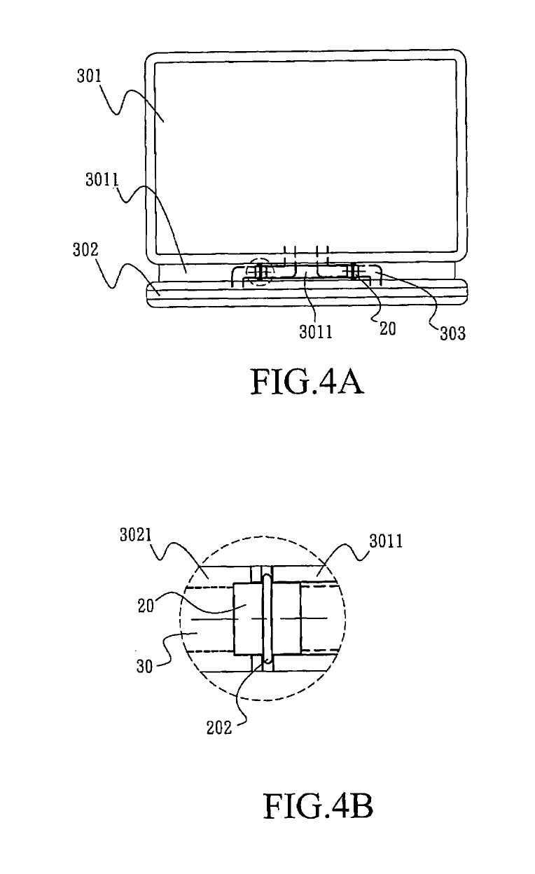

Referring to FIGS. 4A and 4B, an electronic device 30 of a second embodiment of the present invention is provided. The electronic device 30 includes a first base 301 and a second base 302 pivotally connected to each other, so that the first base 301 may be rotated relative to the second base 302.

The first base 301 has a first pivot portion 3011, and the second base 302 has two second pivot portions 3021. The first pivot portion 3011 is located between the two second pivot portions 3021, thus first pivot portion 3011 is adjacent to and pivotally connected to the two second pivot portion 3021.

The protecting device 20 is disposed across the first pivot portion 3011 and one of the two second pivot portions 3021, and its passing portion 2011 is for an electrical cable 303 passing through. Two ends of the electrical cable 303 are respectively connected to the first base 301 and the second base 302. Thus the protecting device 20 prevents the electrical cable 303 from being worn and damaged by the friction generated by the relative rotation of the first base 301 and the second base 302. Then the lifetime of the cable 303 is effectively extended. Moreover, the electronic device 30 as described above refers to a flip-up electronic device, for example, a notebook, PDA (Personal Digital Assistant), cellular phone, or GPS Navigator (Global Positioning System Navigator), etc.

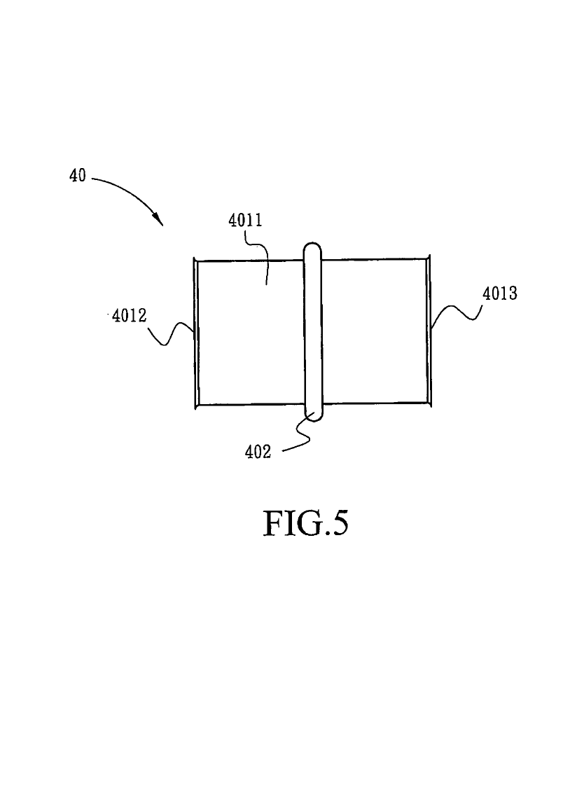

Referring to FIG. 5, a protecting device 40 of a third embodiment of the present invention is provided. The protecting device 40 for an electrical cable is a hollow tube with a hollow passing portion 4011, and two ends of the protecting device 40 are a first opening 4012 and a second opening 4013 respectively. Also, an annular coupling portion 402 is formed on the external peripheral of the tube 401. The first opening 4012 and the second opening 4013 are diverging nozzles, such that the cable may pass through the passing portion 4011 smoothly and friction generated is reduced. Moreover, the tube 401 can be made of a flexible material so as to reduce the damage due to friction.

Above all, through the implementation of the protecting device for electrical cable according to the present invention, the electrical cables can be effectively protected, such that their lifetime can be extended, which indeed effectively protects the electrical cables.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A protecting device for electrical cable, which is disposed in a base for an electrical cable passing through thereof, comprising:
a hollow tube with a first opening and a second opening respectively for the electrical cable passing through, wherein the tube is disposed in the base and protruding outward; and
an annular coupling portion formed on the external peripheral of the tube for the tube being coupled with the base and positioned.

2. The protecting device of claim 1, wherein the first and second openings are diverging nozzles.

3. The protecting device of claim 1, wherein the tube is made of flexible material.

4. The protecting device of claim 1, wherein the coupling portion is a flange.

5. A electronic device, comprise two bases pivotally connected to each other;
a hollow tube disposed across the pivot portions of the two bases; and
a cable passing through the tube between the two base, wherein the two end of the cable are respectively connected to the bases.

6. The protecting device of claim 5, wherein each of the two is formed with a pivot portion, the two pivot portion are pivotally connected to each other, and the tube is disposed across the two pivot portions.

7. The protecting device of claim 6, wherein an annular coupling portion is formed on the external peripheral of the tube for the tube being coupled with at least one of the base and positioned.

8. The protecting device of claim 6, wherein the first and second openings are diverging nozzles.

9. The protecting device of claim 6, wherein the tube is made of flexible material.

10. The protecting device of claim 6, wherein the coupling portion is a flange.
